(19) United States
(12) Patent Application Publication
(10) Pub. No.: US 2009/0071372 A1
(43) Pub. Date: Mar. 19, 2009

(54) WATER-BASED COATING COMPOSITION AND HEAT-SHIELDING COATING

(75) Inventors: Susumu Abe, Aichi-ken (JP); Takeshi Yanagihara, Aichi-ken (JP); Shojiro Ishibashi, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NIHON CHUO KENKYUJO CO., LTD., Nagoya-shi (JP)

(21) Appl. No.: 11/909,731

(22) PCT Filed: Mar. 31, 2006
(86) PCT No.: PCT/JP2006/307507

§ 371 Date: Sep. 26, 2007

(30) Foreign Application Priority Data
Mar. 31, 2005 (JP) 2005-104928

(51) Int. Cl. C09D 5/00

(52) U.S. Cl. 106/287.34

(57) ABSTRACT

The problem to be solved by the present invention is to provide a thermal shielding coating exhibiting high thermal shielding properties. The water-based coating composition in accordance with the present invention is characterized by inorganic particles inclusive of spherical metal oxide particles being contained therein. Various chemical compounds, etc. are contained in the water-based coating composition, but by adding spherical metal oxide particles, it has become possible that the water-based coating composition exhibits high solar reflecting properties, as described before. Conventionally, the present inventors have developed inorganic particles exhibiting increased sphericities, and in the course of the development of the inorganic particles exhibiting increased sphericities, they have found that the inorganic particles exhibiting increased sphericities can be dispersed in liquid with very high concentrations, and have contemplated the application of the inorganic particles exhibiting increased sphericities to the coating composition. They have confirmed that the thermal shielding properties are also improved as the result of a large amount of inorganic particles which are excellent in solar reflecting properties being able to be contained in the coating composition, and have completed the present invention.

### TECHNICAL FIELD

The present invention relates to a water-based coating composition and a thermal shielding coating.

### BACKGROUND ART

Recently, energy-saving consciousness has been enhanced and legal controls for saving energy has been strengthened, and accordingly, the improvement of the energy efficiency has been demanded. Under these circumstances, in order to improve the cooling efficiency in various buildings, vehicles, etc. and improve the thermal shielding thereof, there have been proposed thermal shielding coatings with thermal shielding properties against sunlight (NIPPON PAINT News Release, Jul. 24, 2000, NIPPON PAINT Co., Ltd. Internet

<URL:http://www.nipponpaint.co.jp/news/2000/wn0724.html>)

### DISCLOSURE OF THE INVENTION

### Problem to be Solved with the Invention

The present invention has an object of providing a water-based coating composition which exhibits higher thermal shielding properties, and providing a thermal shielding coating using properties of such water-based coating composition.

### Means for Solving Problem

Conventionally, the present inventors have developed inorganic particles with high sphericities. During the development of the inorganic particles with high sphericities, they have found that the inorganic particles with high sphericities can be dispersed in liquid with very high concentrations, and have contemplated the application thereof to coating compositions. The present inventors have confirmed that the thermal shielding properties are also improved due to the addition of a large amount of inorganic particles with excellent solar reflecting properties to the liquid, and have completed the following invention.

Namely, the water-based coating composition in accordance with the present invention is characterized in that inorganic particles inclusive of spherical metal oxide particles are contained therein. The water-based coating composition is composed of various chemical compounds, etc., but by adding the spherical metal oxide particles, the exhibition of high solar reflecting properties becomes possible, as described above.

It is particularly preferable that the specific surface area of the above-described spherical metal oxide particles is 30 m²/g or less. By adjusting the specific surface area in this range, it becomes possible to add a larger amount of spherical metal oxide particles to the water-based coating composition. Examples of these methods of producing spherical metal oxide particles include the method of oxidizing metal powders in an oxygen-containing atmosphere, and it is preferable to add the spherical metal oxide particles obtained using this method to the water-based coating composition. In addition, it is also preferable that the above-described spherical metal oxide particles are produced using the flame fusion method.

And it is preferable that the above-described spherical metal oxide particles are composed of silica. In addition, it is possible to increase the content of the above-described inorganic particles to 60 mass parts or more in the case of the mass of non-volatile components other than the inorganic particles being 100 mass parts. By adding the inorganic particles in this range, higher performance can be exhibited. In particular, it is preferable that substantially no inorganic particle other than the spherical metal oxide particles is contained. In this case, it is preferable that the sphericities of the above-described spherical metal oxide particles are 0.7 or more.

And, the thermal shielding coating in accordance with the present invention, which is capable of solving the above-described problems, contains the above-described water-based coating composition of the present invention. Since the above-described water-based coating composition contains spherical metal oxide particles, the thermal shielding coating in accordance with the present invention exhibits high solar reflecting properties so that high thermal shielding properties can be effected.

### Effects of the Invention

The water-based coating composition in accordance with the present invention can exhibit high solar reflecting properties due to the addition of the spherical metal oxide particles. Therefore, the thermal shielding coating which has adopted this water-based coating composition can be expected to exhibit enhanced performance.

### Best Mode for Carrying out the Invention

Hereinafter, the water-based coating composition and the thermal shielding coating in accordance with the present invention will be explained in detail. The water-based coating composition and the thermal shielding coating in accordance with the present invention are not limited to the following mode, but can be embodied in various modes to which such modifications, improvements, etc. as to be performed by any one skilled in the art are applied, without departing from the spirit and the scope of the present invention.

<Water-Based Coating Composition and Thermal Shielding Coating>

The water-based coating composition in accordance with the present invention is composed of inorganic particles inclusive of spherical metal oxide particles. The configuration of the water-based coating composition in accordance with the present invention is not limited specifically, but examples thereof include the emulsion system in which binders, etc. are dispersed in water as emulsion, the system containing water-soluble binders, etc. The thermal shielding coating in accordance with the present invention contains the water-based coating composition in accordance with the present invention.

In this case, the composition of the spherical metal oxide particle is not limited specifically, but silicon, aluminum, titanium, zirconium, etc. are listed as the metal to be contained therein. It is preferable to use silica which is derived from siliconmetal from the viewpoint of the costs, performance, etc. It is preferable that substantially no inorganic particle other than the spherical metal oxide particles is contained, but if required, it is possible to contain inorganic particles other than the spherical metal oxide particles. For example, pigments adapted to exhibit required coating colors may be contained.

The configuration of the spherical metal oxide particles is not limited specifically provided that they have a spherical configuration, but the following configuration is preferable. First, the specific surface area of 30 m²/g or less is preferable, and 10 m²/g or less is more preferable. As the specific surface area decreases, the configuration becomes more similar to that of spheres so that the filling properties into the water-based coating composition can be increased. The specific surface area is the value measured with the BET method using nitrogen.

And, it is preferable that the sphericity of the spherical metal oxide particle is 0.7 or more, and more preferably 0.8 or more. In this case, “sphericity” in the present specification is calculated as the value which is calculated from the equation of (sphericity)={4π×(area)÷(circumferential length)²} wherein area and circumferential length are those of particle observed in photographs taken using SEM. As the sphericity approaches 1, the particle approaches a true sphere. More specifically, the mean value of the sphericities of 100 particles, which have been measured using the image processing system, are adopted.

With respect to the particle diameters of the spherical metal oxide particles, the volume mean particle diameter thereof preferably ranges from 0.05 μm to about 20 μm, and more preferably ranges from 0.2 μm to about 10 μm. By adjusting the particle diameters of the spherical metal oxide particles in this range, sufficient solar reflecting properties and smoothness of coated films after drying can be both effected.

Such spherical metal oxide particles may be produced using any process, but preferably produced using the method of obtaining particles by oxidizing metal powders in an oxygen-containing atmosphere (VMC method), the flam fusion method, etc.

The VMC method is the method of forming a chemical flame in an oxygen-containing atmosphere using a burner, and adding metal powders adapted to compose one part of objective oxide particles to the chemical flame by such an amount as to form a dust cloud, thereby causing deflagration to obtain oxide particles.

Hereinafter, the process of the VMC method will be explained. First, an oxygen-containing gas as a reaction gas is made to charge a vessel, and a chemical flame is formed in this reaction gas. Next, metal powders are added to this chemical flame to form a dust cloud with a high concentration (500 g/m³ or more). As a result, heat energy is applied to surfaces of the metal powders with this chemical flame, and consequently, surface temperatures of the metal powders rise, and a metal vapor spreads outwardly from the surfaces of the metal powders. This metal vapor reacts on the oxygen gas to be ignited, thereby forming a flame. Heat generated with this flame further accelerates the vaporization of the metal powders to mix the generated metal vapor with the reaction gas, thereby spreading ignition sequentially. At this time, the metal powders themselves destruct to scatter, thereby accelerating the flame spreading. After combustion, a resultant gas is cooled naturally to form a cloud of oxide particles. The obtained oxide particles are collected using a bag filter, an electrostatic percipitator, etc.

The VMC method uses the principle of dust explosion. With the VMC method, a large amount of oxide particles can be obtained instantaneously. The obtained oxide particles have an approximately spherical configuration. The metal powders to be added depends on the composition of objective spherical metal oxide particles, for example, in order to obtain silica particles, silicon powders are added, and in order to obtain alumina particles, aluminum powders are added. By adjusting the particle diameter and the adding amount of the silicon powder, etc. to be added along with the flame temperature, etc., it is possible to adjust the particle diameter of the obtained oxide particles. And, the metal oxide powders can be also added as raw materials in addition to metal fine powders.

The present spherical silica particles can be produced using the flame fusion method as the dry method, the combustion method such as PVS (Physical Vapor Synthesis) method, etc., and the precipitation method, the gel method, etc. as wet methods. The flame fusion method is the method of producing spherical metal oxide particles by powdering metal oxide which composes the objective spherical metal oxide particles with pulverizing, etc., adding the same into the flame for fusion, and cooling for solidification.

In this case, in order to improve the adhesion of the spherical metal oxide particles to a binder, etc. contained in the water-based coating composition, they can be subjected to a surface treatment. For example, various coupling agents such as silane-based, titanate-based, aluminate-based, and zirconate-based coupling agents, and various surfactants such as cationic, anionic, ampholytic, and neutral surfactants can be mixed.

The water-based coating compositions can contain generally contained compositions other than the inorganic particles. Examples thereof include binders, dispersants of dispersing inorganic particles such as the spherical metal oxide particles in water, emulsifying agents, etc. For example, compositions to be contained in the water-based coating compositions, such as a water-based acryl coating, a water-based alkyd-polyester coating, a water-based polyurethane coating, a water-based fluorine resin coating, a water-based epoxy coating, a silicone modified acryl coating, etc., can be arbitrarily contained. With respect to these compositions, generally available compositions can be adopted as they are so that further detailed explanations will be omitted.

It is preferable that inorganic particles contained in non-volatile components of the present water-based coating composition are 60 mass parts or more, more preferably 96 mass parts or more, and much more preferably 130 mass parts or more in the case of the mass of remaining components other than the inorganic particles being 100 mass parts. In particular, it is preferable that the spherical metal oxide particles are 60 mass parts or more, and more preferably 96 mass parts or more.

### EMBODIMENTS

The water-based coating composition in accordance with the present invention will be explained in more detail based on embodiments thereof.
(Preparation of Test Coatings)

Water-based coating compositions were prepared by adding water to a water base coating Super Hellow (white, blue or gray) manufactured by ASAHIPEN CORP. such that non-volatile components are adjusted to 50% by mass, and mixing spherical silica (manufactured by ADMATECHS CO., LTD., SO-C2, volume mean particle diameter 0. 5 μm, specific surface area 6.5 m²/g, manufactured using the VMC method), spherical silica (manufactured by Tokai Minerals, ES-07, volume mean particle diameter 7.4 μm, specific surface area 4.6 m²/g, manufactured using the flame fusion method) as the spherical metal oxide particles or crushed silica (volume mean particle diameter 10 μm, specific surface area 7.0 m²/g) in 100 mass of a prepared mixture of Super Hellow and water in the ratios shown in TABLE 1 and TABLE 2. In the Comparative example 6, a heat insulating coating on the market was used and evaluated.

TABLE 1

| | | Content of Silica(mass parts) | | Solar | |
|---|---|---|---|---|---|
| | Color | SO-C2 | ES-O7 | Reflectivity(%) | Appearance |
| Embodiment 1 | white | 48 | 0 | 90.0 | no cracking, no peeling |
| Embodiment 2 | blue | 48 | 0 | 83.3 | no cracking, no peeling |
| Embodiment 3 | blue | 65 | 0 | 85.2 | no cracking, no peeling |
| Embodiment 4 | gray | 48 | 0 | 59.3 | no cracking, no peeling |
| Embodiment 5 | gray | 35 | 0 | 65.3 | no cracking, no peeling |
| Embodiment 6 | gray | 0 | 48 | 82.3 | no cracking, no peeling |

TABLE 2

| | | | | | Solar | |
|---|---|---|---|---|---|---|
| | | Content of Silica(mass parts) | | | Reflectivity | |
| | Color | Crushed Silica | SO-C2 | ES-O7 | (%) | Appearance |
| Comparative Example 1 | white | 0 | 0 | 0 | 88.6 | no cracking, no peeling |
| Comparative Example 2 | blue | 0 | 0 | 0 | 72.7 | no cracking, no peeling |
| Comparative Example 3 | gray | 0 | 0 | 0 | 58.2 | no cracking, no peeling |
| Comparative Example 4 | white | 10 | 0 | 0 | — | no cracking, no peeling |
| Comparative Example 5 | white | 48 | 0 | 0 | — | peeling in pieces and |
| | | | | | | impossible of coating |

| | | | |
|---|---|---|---|
| Comparative Example 6 | thermal insulating coating on the market | 84.7 | no cracking, no peeling |

(Evaluation)

Test coatings of embodiments and comparative examples were applied to slate test pieces (300 mm×300 mm) with a thickness of 150 μm, and the solar reflectivities were measured according to JIS R 3105. In addition, coated films with a thickness of 200 μm were formed on similar slate test pieces, and left in the outdoors, and changes in the surface temperature with time were measured. The solar reflectivities are also shown in TABLE 1 and TABLE 2, and the changes in the surface temperature with time are shown in TABLE 3 and TABLE 4.

TABLE 3

| | Time | | | | | |
|---|---|---|---|---|---|---|
| | 10:00 | 11:00 | 12:00 | 13:00 | 14:00 | 15:00 |
| Temperature(° C.) | 32 | 34 | 34 | 38 | 36 | 36 |
| No coating (° C.) | 42.8 | 45.7 | 48.7 | 48 | 45.1 | 43.9 |
| Test coating of Embodiment | 35.1 | 37.8 | 37.5 | 39.4 | 39.3 | 37.8 |
| 1(° C.) | | | | | | |
| Test coating of Compartive | 39.5 | 41.7 | 42.4 | 45.2 | 41.6 | 42 |
| Example 1 (° C.) | | | | | | |
| Test coating of Compartive | 37.6 | 42.6 | 40.9 | 44.6 | 43.5 | 42.7 |
| Example 6 (° C.) | | | | | | |

TABLE 4
First Day

| | Time(Weather) | | | |
|---|---|---|---|---|
| | 10:00(clear) | 12:00(clear) | 14:00(clear) | 16:00(clear) |
| Temperature(° C.) | 9.0 | 13.0 | 14.0 | 11.5 |
| No coating(° C.) | 19.9 | 26.5 | 21.2 | 9.9 |
| Test coating of Embodiment 1(° C.) | 9.9 | 13.5 | 12.8 | 7.3 |
| Test coating of Compartive Example 4 (° C.) | 14.2 | 17.5 | 17.9 | 10.9 |

Second day

| | Time(Weather) | | | |
|---|---|---|---|---|
| | 10:00(clear) | 12:00(clear) | 14:00(clear) | 16:00(cloudy) |
| Temperature(° C.) | 8.0 | 11.0 | 12.0 | 10 |
| No coating(° C.) | 16.5 | 19.9 | 19.2 | 11.5 |
| Test coating of Embodiment 1(° C.) | 8.7 | 11.5 | 11.2 | 8.5 |
| Test coating of Compartive Example 4 (° C.) | 11.1 | 14.9 | 15.5 | 9.8 |

Third day

| | Time(Weather) | | | |
|---|---|---|---|---|
| | 10:00(clear) | 12:00(clear) | 14:00(clear) | 16:00(cloudy) |
| Temperature(° C.) | 10.5 | 13.5 | 15.0 | 12 |
| No coating(° C.) | 20.2 | 24.5 | 23.5 | 14 |
| Test coating of Embodiment 1(° C.) | 11.1 | 14.3 | 14.3 | 10.8 |
| Test coating of Compartive Example 4 (° C.) | 14.9 | 18.2 | 19.7 | 12.5 |

Fourth day

| | Time(Weather) | | | |
|---|---|---|---|---|
| | 10:00(rainy) | 12:00(cloudy) | 14:00(cloudy) | 16:00(cloudy) |
| Temperature(° C.) | 7.0 | 8.0 | 11.0 | 12.5 |
| No coating(° C.) | 10.3 | 9.7 | 14.2 | 13.2 |
| Test coating of Embodiment 1(° C.) | 6.4 | 7.8 | 11.2 | 10 |
| Test coating of Compartive Example 4 (° C.) | 8.2 | 9.1 | 12.8 | 12.2 |

(Results)

As is clarified from the results of Embodiments 1 through 6, the spherical silica as the spherical metal oxide particles was able to be added practically in the ranges from 48 mass parts to 65 mass parts. The crushed silica was able to be added in 10 mass parts (Comparative example 4), but when 48 mass parts is added, the coating applied to the slate test piece became brittle, and cracking and peeling were formed so as not to be used practically (Comparative example 5).

From the measurement results of the surface temperatures in the actual outdoors, which are shown in TABLE 3, it has been clarified that the surface temperatures of the test coating of Embodiment 1, which contains spherical silica, are lower than those when no coating is applied, and can be kept lower than those of Comparative example 1 which does not contain spherical silica, and those of the test coating of Comparative example 6 on the market so that it has been proved that the test coating of Embodiment 1 can have high thermal shielding properties. Therefore, it has been proved that by adding the silica fine particles to the water-based coating composition, the thermal shielding properties can be exhibited.

And from the results shown in TABLE 4, it has been clarified that the surface temperatures of the slate test piece to which the test coating of Embodiment 1 has been applied were kept lower than those of the test coating of Comparative example 4 which contains 10 mass parts of crushed silica so that the test coating of Embodiment 1 exhibits high thermal shielding properties. Therefore, it has been proved that the spherical silica can exhibit higher thermal shielding properties than those of the crushed silica (angular and irregular configuration).

Namely, by forming the metal oxide particles into spherical configurations, they can be added to the water-based coating composition in a great composition ratio, whereas crushed silica was not able to form any practical coated film even when added by the amount approximately equal to that of the spherical silica.

From these results, it can be deduced that though both the spherical silica and the crushed silica exhibit thermal shielding properties, and the crushed silica has the possibility of exhibiting approximately equal thermal shielding properties to those of the spherical silica, the spherical silica which can be added by a large amount can exhibit high thermal shielding properties sufficiently, whereas the crushed silica was not able to be added sufficiently so as not to exhibit approximately equal thermal shielding properties to those of the spherical silica.

1. A thermal shielding coating essentially consisting of a water-based coating composition characterized in that inorganic particles inclusive of spherical metal oxide particles are contained therein.

2. The thermal shielding coating as claimed in claim 1, wherein said spherical metal oxide particles have a specific surface area of 30 m²/g or less.

3. The thermal shielding coating as claimed in claim 1, wherein said spherical metal oxide particles are particles obtained by oxidizing metal powders in an oxygen-containing atmosphere.

4. The thermal shielding coating as claimed in claim 1, wherein said spherical metal oxide particles are produced using the flame fusion method.

5. The thermal shielding coating as claimed in claim 1, wherein said spherical metal oxide particles are composed of silica.

6. The thermal shielding coating as claimed in claim 1, wherein the content of said inorganic particles is 60 mass parts or more in the case of the mass of non-volatile components other than said inorganic particles being 100 mass parts.

7. The thermal shielding coating as claimed in claim 1, wherein substantially no inorganic particle other than said metal oxide particles is contained therein.

8. The thermal shielding coating as claimed in claim 1, wherein said spherical metal oxide particles have a sphericity of 0.7 or more.

9. (canceled)
